(19) United States
(12) Patent Application Publication
(10) Pub. No.: US 2008/0181560 A1
(43) Pub. Date: Jul. 31, 2008

(54) STRUCTURE FOR LIGHT COUPLING IN HEAT-ASSISTED MAGNETIC RECORDING

(75) Inventors: Sung Dong SUH, Seoul (KR); Kook Hyun SUN WOO, Hwaseong-si (KR); Hoo San LEE, Osan-si (KR); Hyun Jei KIM, Seoul (KR); Du Hyun LEE, Suwon-si (KR); Eun Hyoung CHO, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/844,004

(22) Filed: Aug. 23, 2007

(30) Foreign Application Priority Data
Jan. 29, 2007 (KR) 10-2007-0009125

(51) Int. Cl. G02B 6/26

(52) U.S. Cl. 385/31

(57) ABSTRACT

A light-coupling structure in a type of heat-assisted magnetic recording is provided, the structure not needing a separate additional slider or a suspension arm through reduction in variation amounts of coupling due to vibrations, and being realized as a high efficient, low-cost structure with compact size. The light-coupling structure in a type of heat-assisted magnetic recording (HAMR) includes: a waveguide having, at its one end, a mirror part inclined at a certain angle; a slider having one of a groove provided along a width direction of one side thereof contacting the waveguide and a via hole provided along a width direction of one side thereof contacting the waveguide; and a fiber butt-connected to the waveguide by means of a connector provided parallel with the slider.

### CROSS-REFERENCE TO RELATED APPLICATION

This application claims priority from Korean Patent Application No. 10-2007-0009125 filed on Jan. 29, 2007, in the Korean Intellectual Property Office, the disclosure of which is incorporated herein in its entirety by reference.

### BACKGROUND OF THE INVENTION

1. Field of the Invention

Structures consistent with the present invention relate to a manner of heat-assisted magnetic recording (HAMR), which is the next generation technology of recording data on more stable media using laser heating, and more particularly to a light-coupling structure in a type of HAMR for light-coupling to waveguides integrated in a magnetic head from a light source without a separate suspension or an actuator.

2. Description of the Related Art

As generally known in the art, HAMR means a concept in which a recording medium is locally heated to reduce coercivity thereof, so that a magnetic recording field applied during a transient magnetic softening of the recording medium occurring due to the heat source further facilitates magnetization of the recording medium.

In such an HAMR, a smaller-grained medium having higher magnetic anisotropy at room temperature may be used in order to guarantee recording in increasing area densities or preferred, sufficient thermal stability. The HAMR can be adapted to any magnetic storage medium, including an inclined medium, a longitudinal medium, a vertical medium, and a patterned medium.

The above-mentioned HAMR needs the technology for transmitting a great quantity of light power with spots of 50 nm or less to a limited recording medium. According to a recent tendency of designing HAMR heads, a thin film waveguide is provided on AlTiC (slider) to guide light toward a storage medium for local heating of the storage medium. Lattices may be used for light transmission to the waveguide.

However, the above-mentioned related art HAMR has a problem in that a light-coupling mechanism from a light source to a waveguide is complicated. That is, it needs to provide a grating coupler on the waveguide, making the recording process complicated. In addition, for light launching on the waveguide using the grating coupler, a collimated input beam is needed and angular alignment of the beam should be controlled at 0.15 degrees or less.

Moreover, many optical parts are needed for forming the collimated input beam, and proper arrangement and precise positioning thereof should be carried out. Furthermore, for installation and control of collimating optics, as shown in FIG. 1, there are needed a reference slider 180 and a suspension arm 182 provided on one side of the reference slider 180.

Meanwhile, among the collimated input beams, if there are a few beams that are not coupled to the grating coupler, the beams are reflected and travel to a recording medium. Such scattered beams problematically act as noise components.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

An aspect of the present invention provides a light-coupling structure in a type of heat-assisted magnetic recording, the structure being realized as a high efficient, low-cost structure through making it in compact size.

Another aspect of the present invention provides a light-coupling structure in a type of HAMR, the structure including: a waveguide having on one end a mirror part inclined at a certain angle; a slider having a groove provided along a width direction of one side thereof contacting the waveguide; and a fiber butt-connected to the waveguide by means of a connector provided parallel with the slider.

In accordance with an exemplary embodiment of the present invention, there is provided a light-coupling structure in a type of HAMR, the structure including: a waveguide having on one end a mirror part inclined at a certain angle; a slider having a via hole provided along a width direction of one side thereof contacting the waveguide; and a fiber butt-connected to the waveguide by means of a connector provided parallel with the slider.

In an exemplary embodiment of the present invention, the mirror part may be inclined at 45 degrees.

In an exemplary embodiment of the present invention, the mirror part may be formed by cutting.

In an exemplary embodiment of the present invention, the mirror part may be coated with any one element selected from Au, Ag, and Al, by a high-reflective (HR) coating.

In an exemplary embodiment of the present invention, the connector may be a loose tube.

In an exemplary embodiment of the present invention, upon the butt-connection, a space between the fiber and the waveguide may be UV-cured with epoxy.

In an exemplary embodiment of the present invention, the groove may have a sectional shape of a “U” or a “V”.

In an exemplary embodiment of the present invention, a lid may be further provided for stable mounting to the fiber according to use of the groove.

In an exemplary embodiment of the present invention, an index matching fluid (IMF) may be partially filled in the via hole and may be UV-cured.

In an exemplary embodiment of the present invention, a single mode fiber (SMF) may be inserted into the IMF-filled portion and may be bonded with thermally curable epoxy (TCE) at the same time.

### BRIEF DESCRIPTION OF THE DRAWINGS

The above and other aspects of the present invention will be more apparent from the following detailed description taken in conjunction with the accompanying drawings, in which:

FIG. 1 is a schematic front view illustrating the state in which a reference slider and a suspension arm, which are used in a related art type of HAMR, are installed;

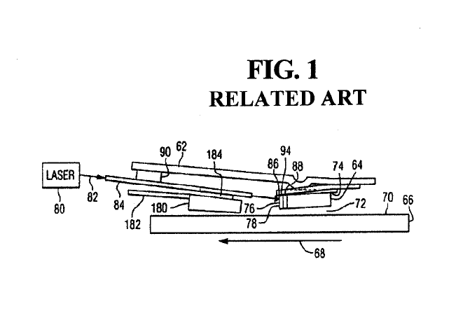

FIG. 2 is a diagrammatical view of a light-coupling structure in a type of HAMR according to an exemplary embodiment of the present invention;

FIG. 3 is a diagrammatical view of a light-coupling structure in a type of HAMR according to another exemplary embodiment of the present invention;

FIG. 4 is a process view illustrating the state in which the light-coupling structure in the type of HAMR according to the present invention is adapted to AlTiC; and

FIG. 5 is a diagrammatical view illustrating the method of forming the light-coupling structure illustrated in FIG. 3.

### DETAILED DESCRIPTION OF THE EXEMPLARY EMBODIMENTS OF THE INVENTION

Hereinafter, a light-coupling structure according to the present invention will be described with reference to the accompanying drawings. In the following description and drawings, the same reference numerals are used to designate the same or similar components, and so repetition of the description on the same or similar components will be omitted.

Generally, a HAMR head uses a recording medium having high anisotropy energy in order to guarantee super-high density recording or thermal stability. For recording information, such recording medium should be locally heated to reduce coercivity thereof because it cannot be magnetized by only a magnetic field generated from the existing head.

To this end, the light-coupling structure includes a waveguide serving as a passage through which light propagates to an aperture, such as a nano aperture, generating light to an existing perpendicular magnetic recording (PMR) head, and a fiber transmitting light from a light source to the waveguide.

The light source is mounted on an E-block having high thermal conductivity to secure thermal stability to which a fiber having small propagation loss may be connected because a distance to a head is considerably long.

For high efficient coupling, a difference of effective index between the waveguide and a single mode fiber (SMF) should be small. In addition, a mode profile should not be too different. In addition, a characteristic of an exemplary embodiment of the present invention uses the technology of a three dimensional optical interconnector.

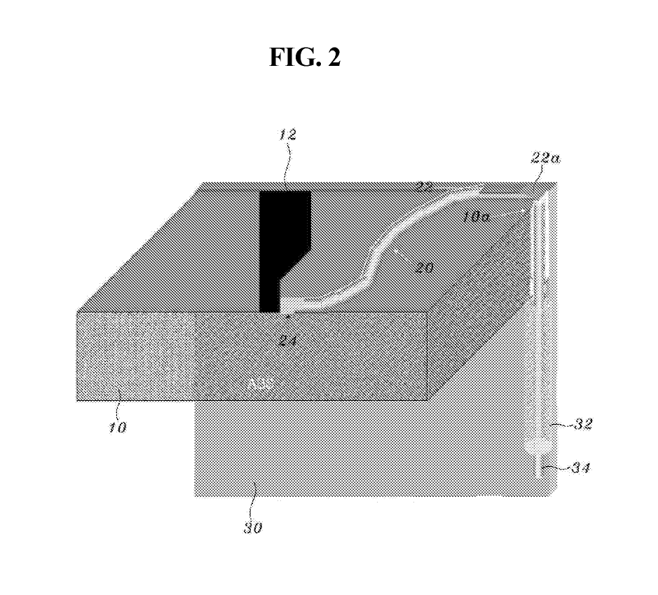

FIG. 2 is a diagrammatical view of a light-coupling structure in a type of HAMR according to an exemplary embodiment of the present invention. Referring to this drawing, an input 22 of a waveguide 20 is provided, on one end, with a mirror part 22a inclined at 45 degrees and formed by cutting, and the mirror part 22a is coated with Ag, Al, preferably, Au, by a high-reflective (HR) coating.

At this time, in order that a fiber 34 is butt-connected to the input 22 of the waveguide 20, a groove 10a having a “U” or a “V” sectional shape is formed along a width direction of one side of AlTiC 10, i.e., a slider, contacting a loose tube 32.

Further, in using the groove 10a for more stable mounting with the fiber 34, a lid (not shown) may be provided to surround the outer circumference of the fiber 34. Numeral 12 in FIG. 2 denotes a main pole, 24 denotes a C-aperture bent in “L” type, and 30 denotes a suspension arm.

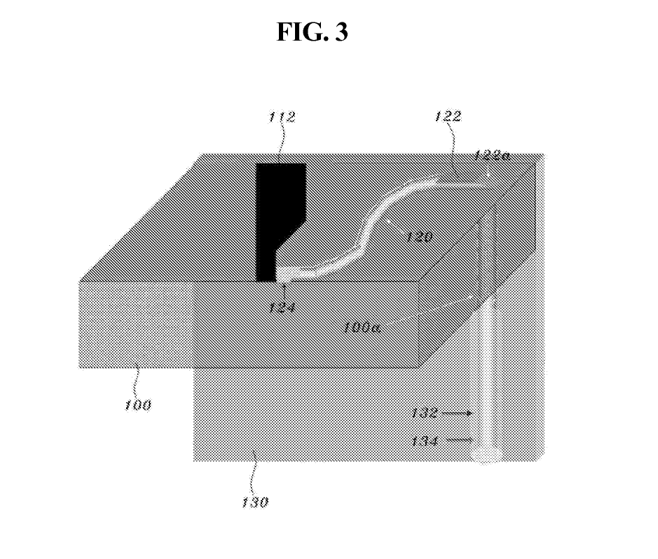

FIG. 3 is a diagrammatical view of a light-coupling structure in a type of HAMR according to another exemplary embodiment of the present invention. As illustrated in this drawing, an input 122 of a waveguide 120 is provided, on one end, with a mirror part 122a inclined at 45 degrees and formed by cutting, and the mirror part 122a is coated with Au, Ag, or Al by a high-reflective (HR) coating.

At this time, in order that a fiber 134 is butt-connected to the input 122 of the waveguide 120, a via hole 100a is formed along a width direction of one side of AlTiC 100 contacting a loose tube 132. Reference numeral 112 in FIG. 3 denotes a main pole, 124 denotes a C-aperture bent in “L” type, and 130 denotes a suspension arm.

Upon butt-connection, a space between the fiber and the waveguide is generally maintained at 10 nm or less, in which index matching epoxy is filled and cured so that the fiber is securely fixed thereto, thereby minimizing variation in coupling with respect to the suspension movement.

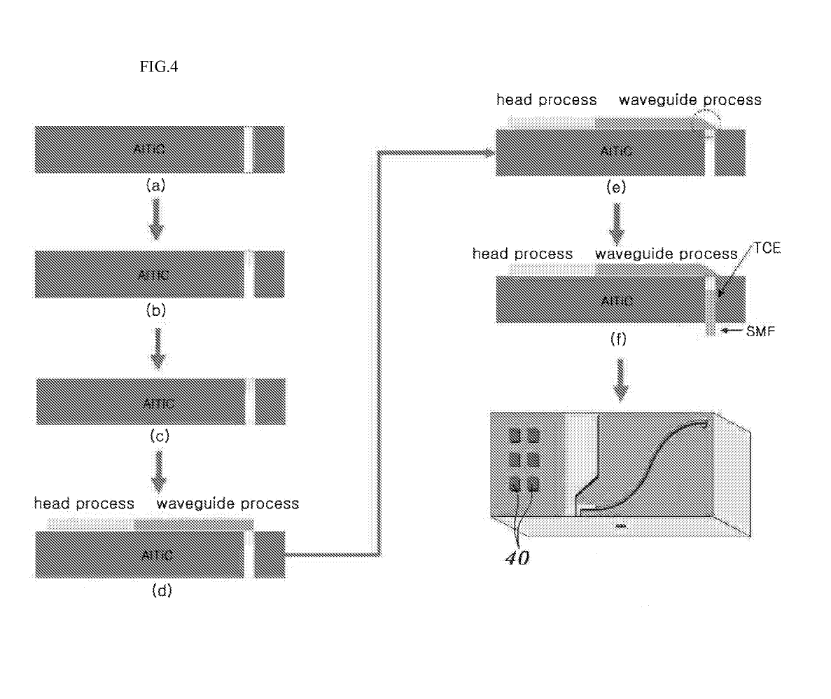

FIG. 4 is a process view illustrating the state in which the light-coupling structure in the type of HAMR according to the present invention is adapted to AlTiC, wherein operation (a) illustrates that the via hole is formed along a width direction of AlTiC, and operation (b) illustrates that an index matching fluid (IMF) is partially filled in the via hole.

In the AlTiC, (c) the filling surface is processed with a chemical and mechanical polishing (CMP), and (d) a head and waveguide process is performed on the AlTiC. Then, (e) the mirror part inclined at 45 degrees is formed at one end of the waveguide by cutting, and (f) the SMF is inserted into the portion filled with IMF and is bonded by thermally curable epoxy (TCE) at the same time. In FIG. 4, the light-coupling structure fabricated by the above process is illustrated on the right lower portion of the drawing. A reference numeral 40 in FIG. 4 denotes a pad.

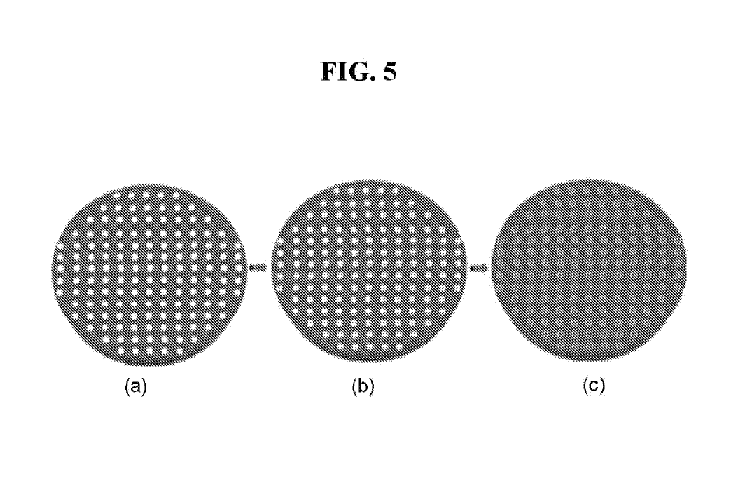

FIG. 5 is a diagrammatical view illustrating the method of forming the light-coupling structure illustrated in FIG. 3, wherein (a) the IMF is applied into the via hole and (b) is UV-cured at the same time. Herein, (c) the CMP is performed.

As set forth before, according to an exemplary embodiment of the present invention, there is provided the light-coupling structure, which is not an optical structure having large free space for the formation of collimated input beam, but is a compact structure using the three dimensional optical interconnector, for launching a beam to waveguides integrated in a magnetic head from a light source without using a separate suspension or an actuator for the control of the coupling efficiency.

In addition, since the separate suspension or actuator is not needed for the control of the coupling efficiency, the structure keeps the stable state with respect to mechanical vibrations. Further, since there is no need to fabricate a grating coupler, which needs high technology and precision in a fabricating process, manufacturing cost is reduced.

Although an exemplary embodiment of the present invention has been described for illustrative purposes, those skilled in the art will appreciate that various modifications, additions and substitutions are possible without departing from the scope and spirit of the invention as disclosed in the accompanying claims.

What is claimed is:

1. A light-coupling structure in a type of heat-assisted magnetic recording (HAMR), the structure comprising:
a waveguide having on one end a mirror part inclined at a certain angle;
a slider having a groove provided along a width direction of one side thereof contacting the waveguide; and
a fiber butt-connected to the waveguide by means of a connector provided parallel with the slider.

2. A light-coupling structure in a type of heat assisted magnetic recording (HAMR), the structure comprising:
a waveguide having on one end a mirror part inclined at a certain angle;
a slider having a via hole provided along a width direction of one side thereof contacting the waveguide; and
a fiber butt-connected to the waveguide by a connector provided parallel with the slider.

3. The light-coupling structure as claimed in claim 1, wherein the mirror part is inclined at 45 degrees.

4. The light-coupling structure as claimed in claim 2, wherein the mirror part is inclined at 45 degrees.

5. The light-coupling structure as claimed in claim 3, wherein the mirror part is formed by cutting.

6. The light-coupling structure as claimed in claim 3, wherein the mirror part is coated with any one element selected from Au, Ag, and Al, by a high-reflective (HR) coating.

7. The light-coupling structure as claimed in claim 3, wherein the connector is a loose tube.

8. The light-coupling structure as claimed in claim 3, wherein upon the butt-connection, a space between the fiber and the waveguide is UV-cured with epoxy.

9. The light-coupling structure as claimed in claim 4, wherein the mirror part is formed by cutting.

10. The light-coupling structure as claimed in claim 4, wherein the mirror part is coated with any one element selected from Au, Ag, and Al, by a high-reflective (HR) coating.

11. The light-coupling structure as claimed in claim 4, wherein the connector is a loose tube.

12. The light-coupling structure as claimed in claim 4, wherein upon the butt-connection, a space between the fiber and the waveguide is UV-cured with epoxy.

13. The light-coupling structure as claimed in claim 1, wherein the groove has a sectional shape of a “U” or a “V”.

14. The light-coupling structure as claimed in claim 13 further comprising a lid for stable mounting to the fiber according to use of the groove.

15. The light-coupling structure as claimed in claim 2, wherein an index matching fluid (IMF) is partially filled in the via hole and is UV-cured.

16. The light-coupling structure as claimed in claim 15, wherein a single mode fiber (SMF) is inserted into the IMF-filled portion and is bonded with thermally curable epoxy (TCE) at a same time.
